(19) United States
(12) Patent Application Publication
(10) Pub. No.: US 2026/0196156 A1
(43) Pub. Date: Jul. 9, 2026

(54) ORGANIC ELECTROLUMINESCENT DEVICES

(71) Applicant: Universal Display Corporation, Ewing, NJ (US)

(72) Inventors: Michael HACK, Carmel, CA (US); Michael Stuart WEAVER, Princeton, NJ (US); Michael O'CONNOR, Yardley, PA (US); Eric A. MARGULIES, Pennington, NJ (US)

(21) Appl. No.: 19/443,325

(22) Filed: Jan. 8, 2026

Related U.S. Application Data
(60) Provisional application No. 63/743,261, filed on Jan. 9, 2025.
(60) Provisional application No. 63/785,827, filed on Apr. 9, 2025.

(51) Int. Cl. G09G 3/20; G09G 3/3208

(52) U.S. Cl. CPC G09G 3/2092; G09G 3/3208; G09G 2300/0452; G09G 2320/0233; G09G 2320/0242; G09G 2320/0626; G09G 2340/0407

(57) ABSTRACT

Embodiments of the disclosed subject matter provide a plurality of pixels, where each pixel of the plurality of pixels may have three or more sub-pixels, and where a first sub-pixel of the three or more sub-pixels of a first pixel of the plurality of pixels emits a first color light. A controller may be communicatively coupled to the plurality of pixels. The controller may be configured to receive an input signal that specifies a luminance for the first sub-pixel and a group of sub-pixels that emit the first color light in N pixels, where the N pixels comprise the first pixel and at least one pixel adjacent to the first pixel, and output an output signal to drive the first sub-pixel at a luminance equal to a sum of luminance values specified in the input signal for the group of sub-pixels that emit the first color light in the N pixels.

### CROSS-REFERENCE TO RELATED APPLICATIONS

This application claims priority to U.S. Patent Application Ser. No. 63/785,827, filed Apr. 9, 2025, and U.S. Patent Application Ser. No. 63/743,261, filed Jan. 9, 2025, the entire contents of each are incorporated herein by reference.

### FIELD

The present invention relates to devices and techniques for adjusting a transient response of sub-pixels, which may be organic light emitting diodes, and devices and techniques including the same.

### BACKGROUND

Opto-electronic devices that make use of organic materials are becoming increasingly desirable for a number of reasons. Many of the materials used to make such devices are relatively inexpensive, so organic opto-electronic devices have the potential for cost advantages over inorganic devices. In addition, the inherent properties of organic materials, such as their flexibility, may make them well suited for particular applications such as fabrication on a flexible substrate. Examples of organic opto-electronic devices include organic light emitting diodes/devices (OLEDs), organic phototransistors, organic photovoltaic cells, and organic photodetectors. For OLEDs, the organic materials may have performance advantages over conventional materials. For example, the wavelength at which an organic emissive layer emits light may generally be readily tuned with appropriate dopants.

OLEDs make use of thin organic films that emit light when voltage is applied across the device. OLEDs are becoming an increasingly interesting technology for use in applications such as flat panel displays, illumination, and backlighting. Several OLED materials and configurations are described in U.S. Pat. Nos. 5,844,363, 6,303,238, and 5,707,745, which are incorporated herein by reference in their entirety.

One application for phosphorescent emissive molecules is a device that is a full color display. Industry standards for such a display call for pixels adapted to emit particular colors, referred to as “saturated” colors. In particular, these standards call for saturated red, green, and blue pixels. Alternatively the OLED can be designed to emit white light. In conventional liquid crystal displays emission from a white backlight is filtered using absorption filters to produce red, green and blue emission. The same technique can also be used with OLEDs. The white OLED can be either a single EML device or a stack structure. Color may be measured using CIE coordinates, which are well known to the art.

As used herein, the term “organic” includes polymeric materials as well as small molecule organic materials that may be used to fabricate organic opto-electronic devices. “Small molecule” refers to any organic material that is not a polymer, and “small molecules” may actually be quite large. Small molecules may include repeat units in some circumstances. For example, using a long chain alkyl group as a substituent does not remove a molecule from the “small molecule” class. Small molecules may also be incorporated into polymers, for example as a pendent group on a polymer backbone or as a part of the backbone. Small molecules may also serve as the core moiety of a dendrimer, which consists of a series of chemical shells built on the core moiety. The core moiety of a dendrimer may be a fluorescent or phosphorescent small molecule emitter. A dendrimer may be a “small molecule,” and it is believed that all dendrimers currently used in the field of OLEDs are small molecules.

As used herein, “top” means furthest away from the substrate, while “bottom” means closest to the substrate. Where a first layer is described as “disposed over” a second layer, the first layer is disposed further away from substrate. There may be other layers between the first and second layer, unless it is specified that the first layer is “in contact with” the second layer. For example, a cathode may be described as “disposed over” an anode, even though there are various organic layers in between.

As used herein, “solution processible” means capable of being dissolved, dispersed, or transported in and/or deposited from a liquid medium, either in solution or suspension form.

As used herein, an “emissive material” may also be described as an “emitter material”. Similarly, an “emitter material” may also be described as an “emissive material”. In other words, the terms “emissive material” and “emitter material” may be used interchangeably.

A ligand may be referred to as “photoactive” when it is believed that the ligand directly contributes to the photoactive properties of an emissive material. A ligand may be referred to as “ancillary” when it is believed that the ligand does not contribute to the photoactive properties of an emissive material, although an ancillary ligand may alter the properties of a photoactive ligand.

As used herein, and as would be generally understood by one skilled in the art, a first “Highest Occupied Molecular Orbital” (HOMO) or “Lowest Unoccupied Molecular Orbital” (LUMO) energy level is “greater than” or “higher than” a second HOMO or LUMO energy level if the first energy level is closer to the vacuum energy level. Since ionization potentials (IP) are measured as a negative energy relative to a vacuum level, a higher HOMO energy level corresponds to an IP having a smaller absolute value (an IP that is less negative). Similarly, a higher LUMO energy level corresponds to an electron affinity (EA) having a smaller absolute value (an EA that is less negative). On a conventional energy level diagram, with the vacuum level at the top, the LUMO energy level of a material is higher than the HOMO energy level of the same material. A “higher” HOMO or LUMO energy level appears closer to the top of such a diagram than a “lower” HOMO or LUMO energy level.

As used herein, and as would be generally understood by one skilled in the art, a first work function is “greater than” or “higher than” a second work function if the first work function has a higher absolute value. Because work functions are generally measured as negative numbers relative to vacuum level, this means that a “higher” work function is more negative. On a conventional energy level diagram, with the vacuum level at the top, a “higher” work function is illustrated as further away from the vacuum level in the downward direction. Thus, the definitions of HOMO and LUMO energy levels follow a different convention than work functions.

Layers, materials, regions, and devices may be described herein in reference to the color of light they emit. In general, as used herein, an emissive region that is described as producing a specific color of light may include one or more emissive layers disposed over each other in a stack.

As used herein, a “red” layer, material, region, or device refers to one that emits light in the range of about 580-700 nm or having a highest peak in its emission spectrum in that region. Similarly, a “green” layer, material, region, or device refers to one that emits or has an emission spectrum with a peak wavelength in the range of about 500-600 nm; a “blue” layer, material, or device refers to one that emits or has an emission spectrum with a peak wavelength in the range of about 400-500 nm; and a “yellow” layer, material, region, or device refers to one that has an emission spectrum with a peak wavelength in the range of about 540-600 nm. In some arrangements, separate regions, layers, materials, regions, or devices may provide separate “deep blue” and a “light blue” light. As used herein, in arrangements that provide separate “light blue” and “deep blue”, the “deep blue” component refers to one having a peak emission wavelength that is at least about 4 nm less than the peak emission wavelength of the “light blue” component. Typically, a “light blue” component has a peak emission wavelength in the range of about 465-500 nm, and a “deep blue” component has a peak emission wavelength in the range of about 400-470 nm, though these ranges may vary for some configurations. Similarly, a color altering layer refers to a layer that converts or modifies another color of light to light having a wavelength as specified for that color. For example, a “red” color filter refers to a filter that results in light having a wavelength in the range of about 580-700 nm. In general, there are two classes of color altering layers: color filters that modify a spectrum by removing unwanted wavelengths of light, and color changing layers that convert photons of higher energy to lower energy. A component “of a color” refers to a component that, when activated or used, produces or otherwise emits light having a particular color as previously described. For example, a “first emissive region of a first color” and a “second emissive region of a second color different than the first color” describes two emissive regions that, when activated within a device, emit two different colors as previously described.

As used herein, emissive materials, layers, and regions may be distinguished from one another and from other structures based upon light initially generated by the material, layer or region, as opposed to light eventually emitted by the same or a different structure. The initial light generation typically is the result of an energy level change resulting in emission of a photon. For example, an organic emissive material may initially generate blue light, which may be converted by a color filter, quantum dot or other structure to red or green light, such that a complete emissive stack or sub-pixel emits the red or green light. In this case the initial emissive material or layer may be referred to as a “blue” component, even though the sub-pixel is a “red” or “green” component.

In some cases, it may be preferable to describe the color of a component such as an emissive region, sub-pixel, color altering layer, or the like, in terms of 1931 CIE coordinates. For example, a yellow emissive material may have multiple peak emission wavelengths, one in or near an edge of the “green” region, and one within or near an edge of the “red” region as previously described. Accordingly, as used herein, each color term also corresponds to a shape in the 1931 CIE coordinate color space. The shape in 1931 CIE color space is constructed by following the locus between two color points and any additional interior points. For example, interior shape parameters for red, green, blue, and yellow may be defined as shown below:

| Color | CIE Shape Parameters |
|---|---|
| Central Red | Locus: [0.6270, 0.3725]; [0.7347, 0.2653]; |
| | Interior: [0.5086, 0.2657] |
| Central Green | Locus: [0.0326, 0.3530]; [0.3731, 0.6245]; |
| | Interior: [0.2268, 0.3321 |
| Central Blue | Locus: [0.1746, 0.0052]; [0.0326, 0.3530]; |
| | Interior: [0.2268, 0.3321] |
| Central Yellow | Locus: [0.373 l, 0.6245]; [0.6270, 0.3725]; |
| | Interior: [0.3 700, 0.4087]; [0.2886, 0.4572] |

More details on OLEDs, and the definitions described above, can be found in U.S. Pat. No. 7,279,704, which is incorporated herein by reference in its entirety.

### SUMMARY

According to an embodiment, an organic light emitting diode/device (OLED) is also provided. The OLED can include an anode, a cathode, and an organic layer, disposed between the anode and the cathode. According to an embodiment, the organic light emitting device is incorporated into one or more device selected from a consumer product, a full color display, an electronic component module, and/or a lighting panel.

According to an embodiment, a device may include a plurality of pixels, where each pixel of the plurality of pixels comprises three or more sub-pixels, and where a first sub-pixel of the three or more sub-pixels of a first pixel of the plurality of pixels emits a first color light. A controller may be communicatively coupled to the plurality of pixels. The controller may be configured to receive an input signal that specifies a luminance for the first sub-pixel and a group of sub-pixels that emit the first color light in N pixels, where the N pixels comprise the first pixel and at least one pixel adjacent to the first pixel, and output an output signal to drive the first sub-pixel at a luminance equal to a sum of luminance values specified in the input signal for the group of sub-pixels that emit the first color light in the N pixels.

The output signal may specify a drive current of zero to turn off sub-pixels that emit the first color light in N−1 pixels of the N pixels, wherein the N−1 pixels do not include the first pixel.

The output signal may be configured to drive the first sub-pixel at a luminance equal to a sum of luminance values for the group of sub-pixels of that emit the first color light of the N pixels when the luminance of the first sub-pixel is below a threshold value, where the threshold value may be 5% of a maximum luminance value of the first sub-pixel, 10% of a maximum luminance value of the first sub-pixel, and/or 20% of a maximum luminance value of the first sub-pixel. The output signal may specify a drive current of zero to turn off sub-pixels that emit the first color light in N−1 pixels of the N pixels, wherein the N−1 pixels do not include the first pixel.

In an embodiment, the controller may be configured to output one or more signals to control which sub-pixel of the N pixels is driven at any given time. The one or more signals that are output by the controller may drive more than one sub-pixel of the N pixels at a time.

In an embodiment, the first color light may be green light. In an embodiment, the first color light may be blue light. In an embodiment, the first color light may be red light. In an embodiment, the first color light may be white light.

In an embodiment, the output signal to drive the first sub-pixel may be 5% of a maximum luminance value of the first sub-pixel, 10% of a maximum luminance value of the first sub-pixel, 15% of a maximum luminance value of the first sub-pixel, and/or 20% of a maximum luminance value of the first sub-pixel when N=4, and where the output signal to drive the first sub-pixel may be 1% of a maximum luminance value of the first sub-pixel, 2% of a maximum luminance value of the first sub-pixel, 3% of a maximum luminance value of the first sub-pixel, 4% of a maximum luminance value of the first sub-pixel, 5% of a maximum luminance value of the first sub-pixel, and/or 10% of a maximum luminance value of the first sub-pixel when N=9 or N=16.

In an embodiment, a value for N may be based on the first color of light to be emitted by the first sub-pixel. The value for N may be highest when the first color light is blue light. The value for N may be highest when the first color light is green light, red light, yellow light, and/or white light.

In an embodiment, when N>1 for the first color light, at least a portion of the plurality of pixels may be grouped together to have one or more active sub-pixels for the first color light, where the grouping forms a super-pixel of the N pixels. In an embodiment, the super-pixel may have a plurality of sub-pixels, and one or more sub-pixels of the plurality of sub-pixels of the super-pixel may be energized at any given time, and where the input signal may comprise a plurality of frames and wherein for at least F frames of the plurality of frames, the sub-pixel of a given frame of the F frames which is active is changed within the super-pixel, so each sub-pixel that emit the first color light within the super-pixel is energized once every F frames. In an embodiment, N may be a perfect square and the super-pixel may comprise the square root of the N pixels in an x-direction of a display and the square root of the N pixels in a y-direction of the display.

In an embodiment, the controller may apply an adjustment value to the output signal to drive the first sub-pixel. The output signal to drive the first sub-pixel may include the sum of luminance values for the group of sub-pixels that emit the first color light multiplied by the adjustment value.

In an embodiment, the output signal may be configured to drive the first sub-pixel at a luminance equal to the sum of luminance values for the group of sub-pixels that emit the first color light when a time response of the first sub-pixel is longer than a threshold time, and wherein the threshold time is at least 25%, at least 50%, at least 100%, at least 200%, at least 300%, and/or at least 400% of the time defined by 1/(F*G), where F is a number of frames per second for the device, and G is a number of grey levels for the first sub-pixel.

In an embodiment, the output signal may be configured to drive the first sub-pixel at a luminance equal to a sum of luminance values specified in the input signal for the group of sub-pixels that emit the first color light in the N pixels is an output a signal to drive the first sub-pixel at a luminance that may be at least 75%, at least 100%, and/or at least 125% of the sum of luminance values specified in the input signal for the group of sub-pixels that emit the first color light in the N pixels.

A consumer electronic device may include a device having a plurality of pixels, where each pixel of the plurality of pixels comprises three or more sub-pixels, and where a first sub-pixel of the three or more sub-pixels of a first pixel of the plurality of pixels emits a first color light. A controller may be communicatively coupled to the plurality of pixels. The controller may be configured to receive an input signal that specifies a luminance for the first sub-pixel and a group of sub-pixels that emit the first color light in N pixels, where the N pixels comprise the first pixel and at least one pixel adjacent to the first pixel, and output an output signal to drive the first sub-pixel at a luminance equal to a sum of luminance values specified in the input signal for the group of sub-pixels that emit the first color light in the N pixels.

The consumer electronic device may be a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video walls comprising multiple displays tiled together, a theater or stadium screen, and/or a sign.

According to an embodiment, a device may include a plurality of pixels, where each pixel of the plurality of pixels may comprise three or more sub-pixels, where a first sub-pixel of the three or more sub-pixels of a first pixel of the plurality of pixels emits a first color light. The device may include a controller communicatively coupled to the plurality of pixels. The controller may be configured to receive an input signal that specifies a luminance for the first sub-pixel and a group of sub-pixels that emit the first color light in N pixels, where the N pixels comprise the first pixel and at least one pixel adjacent to the first pixel. The controller may be configured to reduce the resolution in a localized area of the device, where the localized area includes the first sub-pixel and the group of sub-pixels that emit the first color light in the N pixels.

In an embodiment, the resolution is reduced by N.

According to an embodiment, a device may include a plurality of pixels, where each pixel of the plurality of pixels may comprise three or more sub-pixels, where a first sub-pixel of the three or more sub-pixels of a first pixel of the plurality of pixels emits a first color light. The device may include a controller communicatively coupled to the plurality of sub-pixels. The controller may be configured to receive an input signal that specifies a luminance increase for the first sub-pixel and a group of sub-pixels that emit the first color light in N pixels, where the N pixels comprise the first pixel and at least one pixel adjacent to the first pixel. The controller may be configured to output an output signal to drive the first sub-pixel at a luminance increase equal to at least 25% of a sum of the luminance increase values specified in the input signal for the group of sub-pixels that emit the first color light in the N pixels.

In an embodiment, the input signal may be configured to be used by the controller to display one or more frames on the device, and the output signal may be configured to drive the first sub-pixel for at least a first frame of the one or more frames.

In an embodiment, the luminance increase for the first sub-pixel and a group of sub-pixels that emit the first color light in the N pixels may be for a first frame of the one or more frames to be displayed on the device, relative to a second frame of the one or more frames, where the second frame is to be displayed before the first frame on the device at less than 5 nits, less than 10 nits, less than 25 nits, less than 50 nits, less than 100 nits, and/or greater than 100 nits.

In an embodiment, the luminance of the first sub-pixel and a group of sub-pixels that emit the first color light in the N pixels for the one or more frames directly before the one or more frames for the input signal received by the controller may be 0 nits.

In an embodiment, the luminance of the first sub-pixel and a group of sub-pixels that emit the first color light in N pixels for a first frame of the one or more frames to be displayed on the device, relative to a second frame of the one or more frames, where the second frame is to be displayed before the first frame on the device, may be 0 nits, less than 5 nits, less than 10 nits, less than 25 nits, less than 50 nits, and/or less than 100 nits.

In an embodiment, the output signal may specify a drive current of less than 20% of the sum of the luminance increase to at least one of the sub-pixels that emit the first color light in N−1 pixels of the N pixels.

In an embodiment, the output signal to drive the first sub-pixel may be at a luminance increase equal to at least 50% of the sum of the luminance increase values specified in the input signal for the group of sub-pixels that emit the first color light in the N pixels.

In an embodiment, the output signal to drive the first sub-pixel may be at a luminance increase equal to at least 90% of the sum of the luminance increase values specified in the input signal for the group of sub-pixels that emit the first color light in the N pixels.

In an embodiment, the output signal to drive the first sub-pixel may be at a luminance increase equal to at least 100% of the sum of the luminance increase values specified in the input signal for the group of sub-pixels that emit the first color light in the N pixels.

The output signal to drive the first sub-pixel may be at a luminance increase greater than 100% of the sum of the luminance increase values specified in the input signal for the group of sub-pixels that emit the first color light in the N pixels.

In an embodiment, the input signal may be for a plurality of frames to be displayed on the device, and the output signal to drive the first sub-pixel may be at a luminance increase greater than 100% of the sum of the luminance increase values specified in the input signal for the group of sub-pixels that emit the first color light in the N pixels for one or more frames of the plurality of frames.

In an embodiment, the output signal to drive the first sub-pixels may be at a luminance increase less than 100% of the sum of the luminance increase values specified in the input signal for the group of sub-pixels that emit the first color light in the N pixels for at least one remaining frame of the plurality of frames after the one or more frames of the plurality of frames.

In an embodiment, the input signal may be for a plurality of frames to be displayed on the device, and the output signal to drive the first sub-pixel may be at a luminance increase greater than 25% of the sum of the luminance increase values specified in the input signal for the group of sub-pixels that emit the first color light in the N pixels for one or more frames of the plurality of frames. The output signal to drive the first sub-pixel may be at the specified luminance increase for the first sub-pixel in the received input signal for the remaining frames of the plurality of frames after the one or more frames of the plurality of frames.

In an embodiment, the output signal to drive the group of sub-pixels that emit the first color light in the N pixels may be at the specified luminance increase for the group of sub-pixels that emit the first color light in the N pixels in the received input signal for the remaining frames of the plurality of frames after the one or more frames of the plurality of frames.

In an embodiment, the output signal may specify a drive current of less than 10% of the sum of the luminance increase to at least one of the sub-pixels that emit the first color light in N−1 pixels of the N pixels, where the N−1 pixels do not include the first pixel.

In an embodiment, the output signal may specify a drive current of less than 7% of the sum of the luminance increase to at least one of the sub-pixels that emit the first color light in N−1 pixels of the N pixels, where the N−1 pixels do not include the first pixel.

In an embodiment, the output signal may specify a drive current of less than 5% of the sum of the luminance increase to at least one of the sub-pixels that emit the first color light in N−1 pixels of the N pixels, where the N−1 pixels do not include the first pixel.

In an embodiment, the output signal may drive the first sub-pixel at a luminance increase equal to at least 10% of the sum of the luminance increase values specified in the input signal for the group of sub-pixels that emit the first color light in the N pixels, where the output signal may specify a drive current of less than 10% of the sum of the luminance increase to at least one of the sub-pixels that emit the first color light in N−1 pixels of the N pixels, where the N−1 pixels do not include the first pixel. The output signal may specify a drive current for the N pixels that provides a luminance increase to the group of sub-pixels that emit the first color light in N pixels within plus or minus 20% of the sum of the input signal luminance increase for the first sub-pixel and a group of sub-pixels of the same color in the N−1 pixels.

In an embodiment, the output signal may specify a drive current for the N pixels that provides a luminance increase to the group of sub-pixels that emit the first color light in N pixels within plus or minus 10% of the sum of the input signal luminance increase for the first sub-pixel and a group of sub-pixels that emit the first color light in the N−1 pixels.

In an embodiment, the output signal may specify a drive current for the N pixels that provides a luminance increase to the group of sub-pixels that emit the first color light in N pixels within plus or minus 5% of the sum of the input signal luminance increase for the first sub-pixel and a group of sub-pixels that emit the first color light in the N−1 pixels.

In an embodiment, the first color light may be green light. In an embodiment, the first color light may be blue light. In an embodiment, the first color light may be red light. In an embodiment, the first color light may be white light. In an embodiment, the first color light may be yellow light.

In an embodiment, N may have a value of 2. In an embodiment, N may have a value of 4. In an embodiment, N may have a value of 9. In an embodiment, N may be an integer that is less than 101.

In an embodiment, during a first time period the first sub-pixel for the group of sub-pixels that emit the first color light in the N pixels may be driven at a higher luminance relative to the other sub-pixels that emit the first color light in the N pixels and where during a second time period a second sub-pixel for the group of sub-pixels that emit the first color light in the N pixels may be driven at a higher luminance relative to the other sub-pixels that emit the first color light in the N pixels.

In an embodiment, a first frame of one or more frames of the input signal the first sub-pixel for the group of sub-pixels that emit the first color light in the N pixels may be driven at a higher luminance relative to the other sub-pixels that emit the first color light in the N pixels and where during a second frame of the one or more frames a second sub-pixel for the group of sub-pixels that emit the first color light in the N pixels may be driven at a higher luminance relative to the other sub-pixels that emit the first color light in the N pixels.

In an embodiment, a size of N pixels may be modified by the controller based on a frame rate, a pixel resolution of the input signal, a brightness of the input signal, and/or a color of the input signal.

### BRIEF DESCRIPTION OF THE DRAWINGS

FIG. 1 shows an organic light emitting device.

FIG. 2 shows an inverted organic light emitting device that does not have a separate electron transport layer.

FIG. 3 shows an example of four pixels where at low luminance for one color sub-pixel (green), only one of the four green sub-pixels is energized at any given time, at a luminance equal to the sum of the four sub-pixel luminances from the four pixels according to an embodiment of the disclosed subject matter.

FIG. 4 shows the four pixel arrangement of FIG. 3 that includes a controller to receive an input signal and provide one or more output signals according to an embodiment of the disclosed subject matter.

FIG. 5 shows a plasmonic organic light emitting device.

### DETAILED DESCRIPTION

Generally, an OLED comprises at least one organic layer disposed between and electrically connected to an anode and a cathode. When a current is applied, the anode injects holes and the cathode injects electrons into the organic layer(s). The injected holes and electrons each migrate toward the oppositely charged electrode. When an electron and hole localize on the same molecule, an “exciton,” which is a localized electron-hole pair having an excited energy state, is formed. Light is emitted when the exciton relaxes via a photoemissive mechanism. In some cases, the exciton may be localized on an excimer or an exciplex. Non-radiative mechanisms, such as thermal relaxation, may also occur, but are generally considered undesirable.

The initial OLEDs used emissive molecules that emitted light from their singlet states (“fluorescence”) as disclosed, for example, in U.S. Pat. No. 4,769,292, which is incorporated by reference in its entirety. Fluorescent emission generally occurs in a time frame of less than 10 nanoseconds.

More recently, OLEDs having emissive materials that emit light from triplet states (“phosphorescence”) have been demonstrated. Baldo et al., “Highly Efficient Phosphorescent Emission from Organic Electroluminescent Devices,” Nature, vol. 395, 151-154, 1998; (“Baldo-I”) and Baldo et al., “Very high-efficiency green organic light-emitting devices based on electrophosphorescence,” Appl. Phys. Lett., vol. 75, No. 3, 4-6 (1999) (“Baldo-II”), are incorporated by reference in their entireties. Phosphorescence is described in more detail in U.S. Pat. No. 7,279,704 at cols. 5-6, which are incorporated by reference.

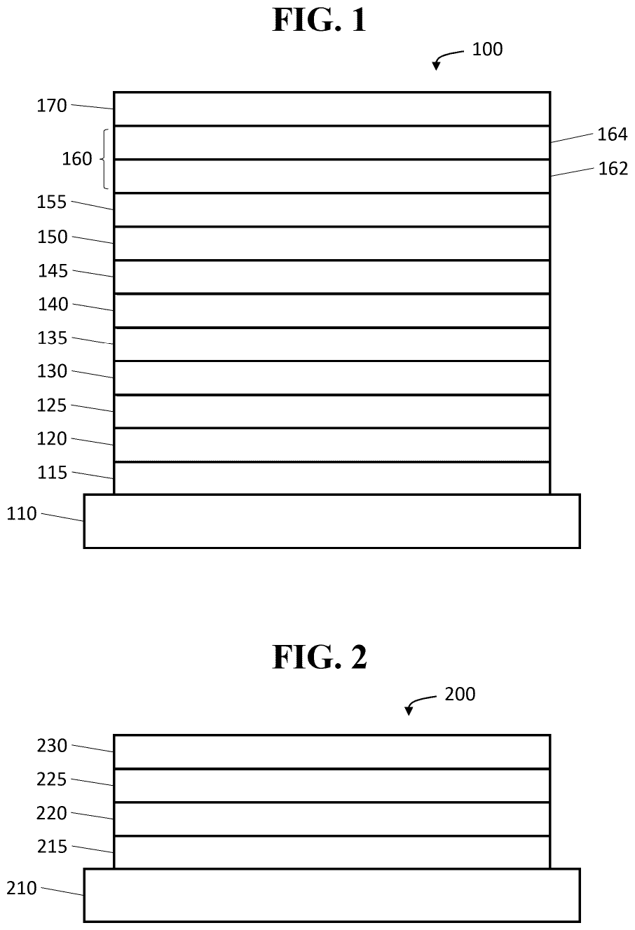

FIG. 1 shows an organic light emitting device 100. The figures are not necessarily drawn to scale. Device 100 may include a substrate 110, an anode 115, a hole injection layer 120, a hole transport layer 125, an electron blocking layer 130, an emissive layer 135, a hole blocking layer 140, an electron transport layer 145, an electron injection layer 150, a protective layer 155, a cathode 160, and a barrier layer 170. Cathode 160 is a compound cathode having a first conductive layer 162 and a second conductive layer 164. Device 100 may be fabricated by depositing the layers described, in order. The properties and functions of these various layers, as well as example materials, are described in more detail in U.S. Pat. No. 7,279,704 at cols. 6-10, which are incorporated by reference.

More examples for each of these layers are available. For example, a flexible and transparent substrate-anode combination is disclosed in U.S. Pat. No. 5,844,363, which is incorporated by reference in its entirety. An example of a p-doped hole transport layer is m-MTDATA doped with F₄-TCNQ at a molar ratio of 50:1, as disclosed in U.S. Patent Application Publication No. 2003/0230980, which is incorporated by reference in its entirety. Examples of emissive and host materials are disclosed in U.S. Pat. No. 6,303,238 to Thompson et al., which is incorporated by reference in its entirety. An example of an n-doped electron transport layer is BPhen doped with Li at a molar ratio of 1:1, as disclosed in U.S. Patent Application Publication No. 2003/0230980, which is incorporated by reference in its entirety. U.S. Pat. Nos. 5,703,436 and 5,707,745, which are incorporated by reference in their entireties, disclose examples of cathodes including compound cathodes having a thin layer of metal such as Mg:Ag with an overlying transparent, electrically-conductive, sputter-deposited ITO layer. The theory and use of blocking layers is described in more detail in U.S. Pat. No. 6,097,147 and U.S. Patent Application Publication No. 2003/0230980, which are incorporated by reference in their entireties. Examples of injection layers are provided in U.S. Patent Application Publication No. 2004/0174116, which is incorporated by reference in its entirety. Barrier layer 170 may be a single- or multi-layer barrier and may cover or surround the other layers of the device. The barrier layer 170 may also surround the substrate 110, and/or it may be arranged between the substrate and the other layers of the device. The barrier also may be referred to as an encapsulant, encapsulation layer, protective layer, or permeation barrier, and typically provides protection against permeation by moisture, ambient air, and other similar materials through to the other layers of the device. Examples of barrier layer materials and structures are provided in U.S. Pat. Nos. 6,537,688, 6,597,111, 6,664,137, 6,835,950, 6,888,305, 6,888,307, 6,897,474, 7,187,119, and 7,683,534, each of which is incorporated by reference in its entirety.

FIG. 2 shows an inverted OLED 200. The device includes a substrate 210, a cathode 215, an emissive layer 220, a hole transport layer 225, and an anode 230. Device 200 may be fabricated by depositing the layers described, in order. Because the most common OLED configuration has a cathode disposed over the anode, and device 200 has cathode 215 disposed under anode 230, device 200 may be referred to as an “inverted” OLED. Materials similar to those described with respect to device 100 may be used in the corresponding layers of device 200. FIG. 2 provides one example of how some layers may be omitted from the structure of device 100.

The simple layered structure illustrated in FIGS. 1 and 2 is provided by way of non-limiting example, and it is understood that embodiments of the invention may be used in connection with a wide variety of other structures. The specific materials and structures described are exemplary in nature, and other materials and structures may be used. Functional OLEDs may be achieved by combining the various layers described in different ways, or layers may be omitted entirely, based on design, performance, and cost factors. Other layers not specifically described may also be included. Materials other than those specifically described may be used. Although many of the examples provided herein describe various layers as comprising a single material, it is understood that combinations of materials, such as a mixture of host and dopant, or more generally a mixture, may be used. Also, the layers may have various sublayers. The names given to the various layers herein are not intended to be strictly limiting. For example, in device 200, hole transport layer 225 transports holes and injects holes into emissive layer 220, and may be described as a hole transport layer or a hole injection layer. In one embodiment, an OLED may be described as having an “organic layer” disposed between a cathode and an anode. This organic layer may comprise a single layer, or may further comprise multiple layers of different organic materials as described, for example, with respect to FIGS. 1 and 2.

Structures and materials not specifically described may also be used, such as OLEDs comprised of polymeric materials (PLEDs) such as disclosed in U.S. Pat. No. 5,247,190 to Friend et al., which is incorporated by reference in its entirety. By way of further example, OLEDs having a single organic layer may be used. OLEDs may be stacked, for example as described in U.S. Pat. No. 5,707,745 to Forrest et al, which is incorporated by reference in its entirety. The OLED structure may deviate from the simple layered structure illustrated in FIGS. 1 and 2. For example, the substrate may include an angled reflective surface to improve out-coupling, such as a mesa structure as described in U.S. Pat. No. 6,091,195 to Forrest et al., and/or a pit structure as described in U.S. Pat. No. 5,834,893 to Bulovic et al., which are incorporated by reference in their entireties.

In some embodiments disclosed herein, emissive layers or materials, such as emissive layer 135 and emissive layer 220 shown in FIGS. 1-2, respectively, may include quantum dots. An “emissive layer” or “emissive material” as disclosed herein may include an organic emissive material and/or an emissive material that contains quantum dots or equivalent structures, unless indicated to the contrary explicitly or by context according to the understanding of one of skill in the art. In general, an emissive layer includes emissive material within a host matrix. Such an emissive layer may include only a quantum dot material which converts light emitted by a separate emissive material or other emitter, or it may also include the separate emissive material or other emitter, or it may emit light itself directly from the application of an electric current. Similarly, a color altering layer, color filter, upconversion, or downconversion layer or structure may include a material containing quantum dots, though such layer may not be considered an “emissive layer” as disclosed herein. In general, an “emissive layer” or material is one that emits an initial light based on an injected electrical charge, where the initial light may be altered by another layer such as a color filter or other color altering layer that does not itself emit an initial light within the device, but may re-emit altered light of a different spectra content based upon absorption of the initial light emitted by the emissive layer and downconversion to a lower energy light emission. In some embodiments disclosed herein, the color altering layer, color filter, upconversion, and/or downconversion layer may be disposed outside of an OLED device, such as above or below an electrode of the OLED device.

Unless otherwise specified, any of the layers of the various embodiments may be deposited by any suitable method. For the organic layers, preferred methods include thermal evaporation, ink-jet, such as described in U.S. Pat. Nos. 6,013,982 and 6,087,196, which are incorporated by reference in their entireties, organic vapor phase deposition (OVPD), such as described in U.S. Pat. No. 6,337,102 to Forrest et al., which is incorporated by reference in its entirety, and deposition by organic vapor jet printing (OVJP), such as described in U.S. Pat. No. 7,431,968, which is incorporated by reference in its entirety. Other suitable deposition methods include spin coating and other solution-based processes. Solution based processes are preferably carried out in nitrogen or an inert atmosphere. For the other layers, preferred methods include thermal evaporation. Preferred patterning methods include deposition through a mask, cold welding such as described in U.S. Pat. Nos. 6,294,398 and 6,468,819, which are incorporated by reference in their entireties, and patterning associated with some of the deposition methods such as ink-jet and OVJP. Other methods may also be used. The materials to be deposited may be modified to make them compatible with a particular deposition method. For example, substituents such as alkyl and aryl groups, branched or unbranched, and preferably containing at least 3 carbons, may be used in small molecules to enhance their ability to undergo solution processing. Substituents having 20 carbons or more may be used, and 3-20 carbons is a preferred range. Materials with asymmetric structures may have better solution processibility than those having symmetric structures, because asymmetric materials may have a lower tendency to recrystallize. Dendrimer substituents may be used to enhance the ability of small molecules to undergo solution processing.

Devices fabricated in accordance with embodiments of the present invention may further optionally comprise a barrier layer. One purpose of the barrier layer is to protect the electrodes and organic layers from damaging exposure to harmful species in the environment including moisture, vapor and/or gases, etc. The barrier layer may be deposited over, under or next to a substrate, an electrode, or over any other parts of a device including an edge. The barrier layer may comprise a single layer, or multiple layers. The barrier layer may be formed by various known chemical vapor deposition techniques and may include compositions having a single phase as well as compositions having multiple phases. Any suitable material or combination of materials may be used for the barrier layer. The barrier layer may incorporate an inorganic or an organic compound or both. The preferred barrier layer comprises a mixture of a polymeric material and a non-polymeric material as described in U.S. Pat. No. 7,968,146, PCT Pat. Application Nos. PCT/US2007/023098 and PCT/US2009/042829, which are herein incorporated by reference in their entireties. To be considered a “mixture”, the aforesaid polymeric and non-polymeric materials comprising the barrier layer should be deposited under the same reaction conditions and/or at the same time. The weight ratio of polymeric to non-polymeric material may be in the range of 95:5 to 5:95. The polymeric material and the non-polymeric material may be created from the same precursor material. In one example, the mixture of a polymeric material and a non-polymeric material consists essentially of polymeric silicon and inorganic silicon.

In an embodiment, the OLED can be configured into a plasmonic OLED. In an embodiment, the organic layer is configured to generate one or more excited states; the OLED comprises a plasmonic material supporting a plasmon polariton mode; and the OLED is configured to transfer at least 5% of energy from said one or more excited states to said plasmon polariton mode.

In an embodiment, the organic layer used to generate the one or more excited states can be an emissive layer as described herein. These excited states can originate from excited-state-forming materials, such as emitter materials disclosed herein, which may include phosphorescent, delayed fluorescent, doublet emitters, inverted singlet-triplet gap emitters, or non-delayed fluorescent compounds. Alternatively, excited states may be produced through the interaction of two components forming an exciplex, or via a sensitizer/acceptor pair within a sensitizing system, as described herein. In an embodiment, the organic layer may comprise one or more emitter materials, one or more host materials, components capable of forming an exciplex, and/or a combination of sensitizer and acceptor materials to establish a sensitizing system, each of which may be employed in the emissive layer of a conventional OLED. While the emissive layer in a conventional OLED is primarily designed to convert excited-state energy directly into photons, the emissive layer in a plasmonic OLED is instead configured to transfer the excited-state energy predominantly into the plasmon polariton mode.

In an embodiment, the plasmonic material is configured to support a plasmon polariton mode. In an embodiment, the plasmon polariton mode can be a surface plasmon polariton mode. In an embodiment, the anode, cathode, or an additional layer disposed between the anode and cathode functions as an enhancement layer comprising the plasmonic material. In an embodiment, the plasmonic material can be comprised of materials having a plasmon resonance, optically active metamaterials, or hyperbolic metamaterials. As used herein, a material having a plasmon resonance is a material in which the real part of the dielectric constant crosses zero in the visible or ultraviolet region of the electromagnetic spectrum. In an embodiment, the real part of the dielectric constant of the plasmonic material is less than zero in part of the ultra-violet, visible, or near infrared regions of the electromagnetic spectrum. In an embodiment, the plasmonic material includes at least one metal. In an embodiment the metal may include, but not limited to, at least one of Ag, Al, Au, Ir, Pt, Ni, Cu, W, Ta, Fe, Cr, Mg, Ga, Rh, Ti, Ru, Pd, In, Bi, Yb, or Ca, alloys or mixtures of these materials, and stacks of these materials. In an embodiment, the enhancement layer is a stack of two materials where the first material acts to promote better growth of the second layer. In an embodiment, the first layer may comprise, but not limited to, Al, Yb, Ca, Ge, In, Bi, Mg, Cr, and Ti or alloys or mixtures of these materials. In an embodiment, the second layer may comprise, but not limited to, Ag, Al, Au, Ir, Pt, Ni, Cu, W, Ta, Fe, Cr, Mg, Ga, Rh, Ti, Ru, Pd, In, Bi, or alloys or mixtures of these materials. In general, a metamaterial is a medium composed of different materials where the medium as a whole acts differently than the sum of its material parts. In particular, we define optically active metamaterials as materials which have both negative permittivity and negative permeability. Hyperbolic metamaterials, on the other hand, are anisotropic media in which the permittivity or permeability are of different sign for different spatial directions. Optically active metamaterials and hyperbolic metamaterials are strictly distinguished from many other photonic structures such as Distributed Bragg Reflectors (“DBRs”) in that the medium should appear uniform in the direction of propagation on the length scale of the wavelength of light. Using terminology that one skilled in the art can understand: the dielectric constant of the metamaterials in the direction of propagation can be described with the effective medium approximation. Plasmonic materials described herein provide methods for controlling the propagation of light that can enhance the device performance in a number of ways.

In an embodiment, the organic layer can generate one or more excited states in response to an excitation mechanism. In an embodiment, the excitation mechanism can include but not limited to an electrical pumping mechanism, a chemical reaction, and an optical pumping mechanism. A voltage applied to the device can electrically create the excited states. Optical pumping may include absorption of photons, including absorption of laser light, electron beam excitation, x-ray and/or microwave excitation, which may require additional up-conversion to achieve visible wavelengths. The excited states may be pumped via plasmon modes or other quasiparticles, as well as radiation-less energy transfer mechanisms like Forster resonance energy transfer (FRET) and single- or multiple-electron transfer either directly from the plasmonic material or another excited state, including Dexter electron transfer (DET).

In an embodiment, the excited-state energy can be directly transferred to the plasmon polariton mode through near-field coupling of the excited-state energy; or through single- or multiple-electron transfer either directly to the plasmonic material or another excited state that subsequently transfers energy into the plasmon mode. In an embodiment, the excited-state energy can be indirectly transferred to the plasmon polariton mode through an energy cascade, including FRET and DET, that transfers excited-state energy to another excited state that subsequently couples energy into the plasmon mode; through photon emission that subsequently interacts with the plasmonic material to achieve the momentum matching conditions required to excite a plasmon polariton; through photon emission that subsequently interacts with a grating or surface roughness resulting in a change in momentum of the photon leading to the new momentum matching conditions required to excite a plasmon polariton; through photon emission and subsequent reabsorption, possibly by another material in another layer or by the emitter material itself (self-absorption), with the resulting excited-state energy coupling to the plasmon mode.

In an embodiment, the percentage of energy transfer from the one or more excited states generated in the organic layer to the plasmon polariton mode supported by the plasmonic material is selected from the group consisting of: at least 5%, at least 10%, at least 20%, at least 30%, at least 40%, at least 50%, at least 60%, at least 70%, at least 80%, and at least 90%. This percentage is also referred to as incoupling fraction.

In order to calculate incoupling fraction, two device samples are made on a substrate with a transparent conducting oxide as the first electrode (anode): Sample 1, a plasmon device with thin ETL (e.g., 100 Å) and 1000 Å Ag cathode; Sample 2, a reference device with a thick ETL (e.g., 600 Å) and 1000 Å Al cathode. Both devices have a thin EML (e.g., 100 Å) with the same components. All other layers remain the same material and same thickness between the devices. Each of the devices has EQE and EL transient measured. It is assumed the plasmon coupling/transfer in the reference device is negligible due to both distance from the EML to the cathode and the Al cathode, though some real but small amounts of plasmon coupling likely exist. This assumption means that the rate constant of plasmon coupling is 0 and a system of equations can be established to solve for the total radiative and non-radiative decay rate constants of the emitter within that host system and thin EML.

$$\frac{{EQE}_{Ref .}}{g} = \frac{{k}_{R}}{( {k}_{R} + {k}_{NR} )} \qquad ( 1 )$$

$$\frac{1}{{τ}_{Ref .}} = {k}_{R} + {k}_{NR} \qquad ( 2 )$$

In equations 1 and 2, where EQE_{Ref.} is the measured EQE value of the reference device (Sample 2), τ_{Ref.} is the time constant fit to the EL transient data of the reference device (in seconds), g is the geometric factor of the device, k_{R} is the radiative rate constant, and k_{NR} is the non-radiative rate constant. For the reference device, the value for g is assumed to be 0-0.4 and must always exceed the measured EQE of the reference device. The geometric factor can be modeled for a given emitter dipole orientation. Since EQE Ref is known, g is known, and τ_{Ref} is known, we can solve the two equations for k_{R} and k_{NR}.

Solving the two equations above gives k_{R} and k_{NR}. These are the decay rate constants of the emissive material within the thin EML. Because the same EML is present in the plasmonic and the reference device we assume that k_{NR} from the reference device is the same in plasmon device. Then for the plasmon device, we can write an expression for the EQE and transient of a plasmonic device where the plasmon incoupling rate constant (k_{P}) is non-zero.

$$\frac{{EQE}_{plasmon .}}{g} = \frac{{k}_{{R}_{plasmon}}}{( {k}_{{R}_{plasmon}} + {k}_{NR} + {k}_{P} )} \qquad ( 3 )$$

$$\frac{1}{{τ}_{plasmon}} = {k}_{{R}_{plasmon}} + {k}_{NR} + {k}_{P} \qquad ( 4 )$$

In equations 3 and 4, where EQEₚₗₐₛₘₒₙ is the measured EQE value of the plasmon device (Sample 1), τₚₗₐₛₘₒₙ is the time constant fit to the EL transient of the plasmon device (in seconds), g is the geometric factor of the device, k_{R}_{ₚₗₐₛₘₒₙ} is the radiative rate constant of the plasmon device, k_{NR} is the non-radiative rate constant (assumed to be the same as the reference device), and k_{P} is the plasmon incoupling rate constant. The value for g is assumed to be the same as the reference device. The two equations above can be used to solve for k_{P} and k_{R}_{ₚₗₐₛₘₒₙ}. Once all rate constants have been found for the plasmon device, the plasmon incoupling fraction (or yield of excitations that are coupled/transferred to the plasmon mode) can be calculated using the following equation 5:

$$Incoupling fraction = \frac{{k}_{P}}{{k}_{{R}_{plasmon}} + {k}_{NR} + {k}_{P}} \qquad ( 5 )$$

In an embodiment, the enhancement layer comprises the plasmonic material exhibiting plasmon resonance that may non-radiatively couple to the excited state forming material in the organic layer, such as the emitter material, and transfer excited-state energy from the excited state forming material to the plasmon polariton modes of the enhancement layer. In an embodiment, the excited state forming material in the organic layer is provided no more than a threshold distance away from the enhancement layer, wherein the threshold distance is a distance at which

$$\frac{{k}_{{R}_{plasmon}}}{{k}_{P}} = \frac{{k}_{R}}{{k}_{NR}} .$$

In another word, if the inequality below holds:

$$\frac{{k}_{{R}_{plasmon}}}{{k}_{P}} < \frac{{k}_{R}}{{k}_{NR}} ,$$

then the organic layer is within a threshold distance. The enhancement layer modifies the effective properties of the medium in which the excited state forming material resides resulting in any or all of the following: a decreased excited state lifetime of emission, a modification of emission line-shape, a change in emission intensity with angle, a change in the stability of the excited state forming material, a change in the efficiency of the device, new hybridized modes in the device including plexitons or plasmon polaritons, and a reduced efficiency roll-off of the device. Placement of the enhancement layer on the cathode side, anode side, or on both sides, or the enhancement layer itself being as the CGL, results in devices which take advantage of any of the above-mentioned effects.

In an embodiment, the enhancement layer is provided as a planar layer. In an embodiment, the enhancement layer has wavelength-sized features that are arranged periodically, quasi-periodically, or randomly, or sub-wavelength-sized features that are arranged periodically, quasi-periodically, or randomly. In an embodiment, the wavelength sized features and the sub-wavelength sized features have sharp edges. Within the enhancement layer, the wavelength sized or sub-wavelength sized features may be all partially etched through, all fully etched through, or both partially and fully etched through the thickness of the plasmonic material. In an embodiment, the wavelength sized or sub-wavelength sized features may be formed from a plurality of nanoparticles. In an embodiment, the enhancement layer may comprise void in areas around and/or between the wavelength sized or sub-wavelength sized features. Here, the void may be “air”, an inert gas, or a void formed by dielectric material, the same or different metal material than the wavelength sized or sub-wavelength sized, organic or inorganic emissive material, etc.

In an embodiment, the device further comprises an outcoupling layer. In an embodiment, the outcoupling layer is disposed over the enhancement layer on a side opposite the organic layer. In an embodiment, the outcoupling layer can also be disposed between the organic layer and the enhancement layer but still outcouples energy from the plasmon mode of the enhancement layer. The outcoupling layer scatters or extracts energy from the plasmon polaritons. In an embodiment, this energy is scattered or extracted as photons to free space. In an embodiment, the percentage of the energy transferred to the plasmon polariton mode being converted into photons in free space, also called as outcoupling fraction, is selected from the group consisting of: at least 5%, at least 10%, at least 20%, at least 30%, at least 40%, at least 50%, at least 60%, at least 70%, at least 80%, and at least 90%. The external quantum efficiency of the plasmonic device can be defined as the product of the plasmon incoupling fraction and the plasmon outcoupling fraction (EQEₚₗₐₛₘₒₙ=incoupling fraction*outcoupling fraction). Factors governing the internal quantum efficiency (IQE) are still valid, including charge recombination efficiency, excited state forming material photoluminescence quantum yield, etc. and the total EQE of the device will be affected by the IQE. In an embodiment, the energy is extracted from the plasmon mode into other modes of the device such as but not limited to the organic waveguide mode, the substrate mode, or another waveguiding mode. If energy is scattered or extracted to the non-free space mode of the device, additional outcoupling schemes may be incorporated to eventually extract the energy to free space.

In order to calculate the outcoupling fraction, a third device sample will need to be made. Sample 3, a plasmon device with thin ETL (e.g., 100 Å), thin Ag cathode (e.g., 300 Å), and outcoupling layer. All other layers in Sample 3 are kept the same as those in Samples 1 and 2. The EQE is measured on Sample 3, where the EQE from the side of the device that the outcoupling layer is designed to extract energy from is EQE_{OL}. Together with the incoupling fraction obtained above, the outcoupling fraction can be obtained through the following equation 6.

$$Outcoupling fraction = \frac{{EQE}_{OL}}{Incoupling fraction} \qquad ( 6 )$$

In an embodiment, the outcoupling layer has wavelength-sized or sub-wavelength sized features that are arranged periodically, quasi-periodically, or randomly. In an embodiment, the outcoupling layer may be composed of a plurality of nanoparticles. In an embodiment, the outcoupling layer is composed of a plurality of nanoparticles disposed over a material. In an embodiment, the outcoupling layer may be tunable by at least one of: varying a size of the plurality of nanoparticles, varying a shape of the plurality of nanoparticles, changing a material of the plurality of nanoparticles, adjusting a thickness of the material, changing the refractive index of the material, adding an additional layer disposed on the plurality of nanoparticles, varying a thickness of the enhancement layer, or varying the material of the enhancement layer. The plurality of nanoparticles of the device may be formed from at least one of metal, dielectric material, semiconductor materials, an alloy of metal, a mixture of dielectric materials, a stack or layering of one or more materials, and/or a core of one type of material that is coated with a shell of a different material with the same type or different type. In an embodiment, the outcoupling layer is composed of at least metal nanoparticles wherein the metal is, but not limited to, Ag, Al, Au, Ir, Pt, Ni, Cu, W, Ta, Fe, Cr, Mg, Ga, Rh, Ti, Ru, Pd, In, Bi, Yb, and Ca, alloys or mixtures of these materials, and stacks of these materials. In an embodiment, the outcoupling layer is composed of dielectric materials such as, but not limited to, indium tin oxide, tin oxide, tin dioxide, silicon nitride, boron nitride, silicon carbide, carbon, diamond, zinc sulfide, zinc selenide, germanium, zinc telluride, potassium niobate, titanium oxide, aluminum oxide, titanium dioxide, antimony oxide, indium dioxide, silicon dioxide, niobium pentoxide, tantalum pentoxide, vanadium oxide, vanadium pentoxide, gallium phosphate, bismuth oxide, gallium arsenide, and/or aluminum gallium compounds, mixtures of these materials, and stacks of these materials. In an embodiment, the nanoparticles have a shape including but not limited to rectangle, cube, cylinder, rectangular pyramid, triangular pyramid, octahedra, hemispheres, cones, truncated cones, a random shape having a flat face, or may have random shapes. In an embodiment, the nanoparticles may have a maximum cross-sectional size within the shape between 5 nm and 1000 nm. In an embodiment, the nanoparticles may have an in-plane dimension (largest dimension measured parallel to the organic layer) between 5 nm and 500 nm. In an embodiment, nanoparticles may have an out-of-plane dimension (largest dimension measured perpendicular to the organic layer) between 5 nm and 500 nm. In an embodiment, the outcoupling layer may have wavelength sized or sub-wavelength sized features that are etched partially or fully through the thickness of the film. Within the outcoupling layer, the wavelength sized or sub-wavelength sized features may be all partially etched through, all fully etched through, or both partially and fully etched through the thickness of the film. In an embodiment, the wavelength sized or sub-wavelength sized features may be arranged periodically, quasi-periodically, or randomly.

In an embodiment, the outcoupling layer may comprise void in areas around and/or between the wavelength sized or sub-wavelength sized features. Here, the void may be “air”, an inert gas, or a void formed by dielectric material, the same or different metal material than the wavelength sized or sub-wavelength sized, organic or inorganic emissive material, etc. In an embodiment, the nanoparticles may have a refractive index selected from the group consisting of: at least 1.5, at least 2.0, at least 2.5, at least 3.0, and greater than 3.0. In an embodiment, the polarization of the emission can be tuned using the outcoupling layer. Varying the dimensionality and periodicity of the wavelength sized or sub-wavelength sized features in the outcoupling layer can select a type of polarization that is preferentially outcoupled to air. In an embodiment, the outcoupling layer can also act as an electrode, i.e., the first or second electrodes described herein. In an embodiment, the outcoupling layer is formed by lithography.

In an embodiment, optically active metamaterials and hyperbolic materials maybe be utilized in the outcoupling layer. In an embodiment, metamaterials or hyperbolic materials with anisotropic optical constants may be used in the outcoupling layer to control emission phase and polarization state of the emission. Metamaterials with high permittivity above 5 may be used in the outcoupling layer to enhance light outcoupling efficiency, narrow the emission line shape and emission wavefront shaping.

In an embodiment, the outcoupling layer may further comprise one or more spacer layers between the enhancement layer and the wavelength sized or sub-wavelength sized features. In an embodiment, the spacer layer may comprise one or more dielectric material and may be referred to as a dielectric layer and/or an intervening layer. In an embodiment, the spacer layer may have a refractive index selected based on a color of light emitted by the excited state forming material. In an embodiment, the spacer layer may be found only in a plasmonic sub-pixel, only in a non-plasmonic sub-pixel or in both. Examples of material suitable for use in the spacer layer include but not limited to dielectric materials, including organic, inorganic, perovskites, oxides, organic materials, semiconductor materials, fluorides, metal organic frameworks (MOFs), covalent organic frameworks (COFs), quantum dots, and may include stacks and/or mixtures of these materials. In an embodiment, the spacer layer may comprise void in areas around and/or between the wavelength sized or sub-wavelength sized features. Here, the void may be “air”, an inert gas, or a void formed by dielectric material, the same or different metal material than the wavelength sized or sub-wavelength sized, organic or inorganic emissive material, etc.

In an embodiment, the outcoupling layer may further comprise one or more over layers disposed over the wavelength sized or sub-wavelength sized features on a side opposite the enhancement layer. In an embodiment, the over layer may include dielectric materials, including organic, inorganic, perovskites, oxides, organic materials, semiconductor materials, fluorides, metal organic frameworks (MOFs), covalent organic frameworks (COFs), quantum dots and may include stacks and/or mixtures of these materials. In an embodiment, the over layer may also act as a barrier to water or oxygen permeation of the device. In an embodiment, the over layer may be a color altering layer or color filtering layer. In an embodiment, the over layer can have a thickness selected from the group consisting of: less than 500 nm, less than 250 nm, less than 100 nm, less than 50 nm, less than 40, less than 30, less than 20, and less than 10 nm. In an embodiment, the over layer may comprise void in areas around and/or between the wavelength sized or sub-wavelength sized features. Here, the void may be “air”, an inert gas, or a void formed by dielectric material, the same or different metal material than the wavelength sized or sub-wavelength sized, organic or inorganic emissive material, etc.

In an embodiment, any of the wavelength sized or sub-wavelength sized features described herein in different layers may have a closest edge to edge spacing between each adjacent feature selected from the group consisting of: less than 10 nm, less than 25 nm, less than 50 nm, less than 200 nm, or less than 1 micron. In an embodiment, the wavelength sized or sub-wavelength sized features may have a center-to-center spacing selected from the group consisting of: less than 100 nm, less than 300 nm, or less than 500 nm. In an embodiment, the wavelength sized or sub-wavelength sized features may form arrays having periodic positional ordering exhibiting hexagonal, square, rectangular, oblique, rhombic, honeycomb, or any other type of lattice symmetry. In an embodiment, the arrays may have a lattice periodicity selected from the group consisting of: at least 100 nm, at least 200 nm, at least 300 nm, at least 400 nm, and more than 500 nm. In an embodiment, the wavelength sized or sub-wavelength sized features may form two or more arrays. Here, each array of the two or more arrays may have the same lattice symmetry or may have different lattice symmetry, or any combination thereof. Additionally, each array of the two or more arrays may have the same lattice periodicity, different lattice periodicity, or any combination thereof. In an embodiment, each array of the two or more arrays may be rotated relative to the other arrays of the two or more arrays. In an embodiment, the wavelength sized or sub-wavelength sized features may form a Penrose design or a Moiré array.

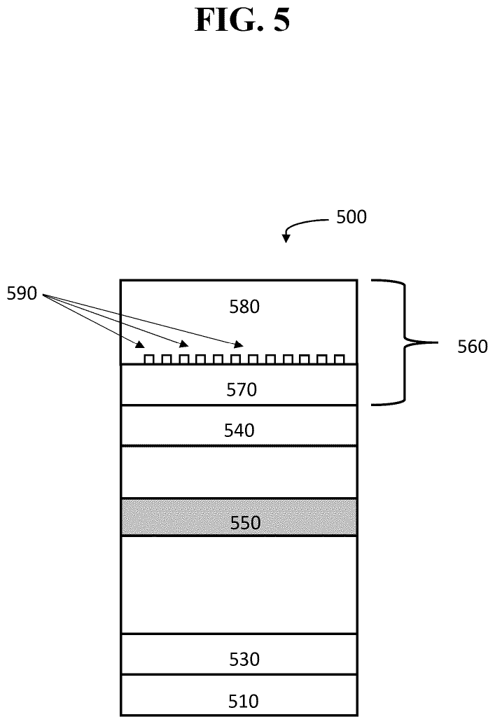

FIG. 5 illustrates an exemplary plasmonic OLED 500. It should be understood that the figures are provided for illustrative purposes only and are not necessarily drawn to scale. In an embodiment, device 500 may comprise a substrate 510, a first electrode 530, an organic layer 550 configured to generate excited states, a second electrode 540, an outcoupling layer 560 comprising a plurality of wavelength-sized or sub-wavelength sized features, such as nanoparticles 590, and optionally a spacer layer 570 and an overlayer 580. In some implementations, an enhancement layer comprising a plasmonic material may be incorporated into the first electrode, the second electrode, or provided as an additional layer disposed over the organic layer. The device may further include one or more additional functional layers commonly employed in conventional OLED described herein in FIGS. 1 and 2, such as HIL, HTL EBL, HBL, ETL, or EIL. Other optional layers typically utilized in OLED described herein, such as protective layers, barrier layers, or color alternating layers, may also be incorporated into the plasmonic OLED without departing from the scope of the present disclosure.

It is believed that the internal quantum efficiency (IQE) of fluorescent OLEDs can exceed the 25% spin statistics limit through delayed fluorescence. As used herein, there are two types of delayed fluorescence, i.e. P-type delayed fluorescence and E-type delayed fluorescence. P-type delayed fluorescence is generated from triplet-triplet annihilation (TTA).

On the other hand, E-type delayed fluorescence does not rely on the collision of two triplets, but rather on the thermal population between the triplet states and the singlet excited states. Compounds that are capable of generating E-type delayed fluorescence are required to have very small singlet-triplet gaps. Thermal energy can activate the transition from the triplet state back to the singlet state. This type of delayed fluorescence is also known as thermally activated delayed fluorescence (TADF). A distinctive feature of TADF is that the delayed component increases as temperature rises due to the increased thermal energy. If the reverse intersystem crossing rate is fast enough to minimize the non-radiative decay from the triplet state, the fraction of back populated singlet excited states can potentially reach 75%. The total singlet fraction can be 100%, far exceeding the spin statistics limit for electrically generated excitons.

E-type delayed fluorescence characteristics can be found in an exciplex system or in a single compound. Without being bound by theory, it is believed that E-type delayed fluorescence requires the luminescent material to have a small singlet-triplet energy gap (AES-T). Organic, non-metal containing, donor-acceptor luminescent materials may be able to achieve this. The emission in these materials is often characterized as a donor-acceptor charge-transfer (CT) type emission. The spatial separation of the HOMO and LUMO in these donor-acceptor type compounds often results in small AES-T. These states may involve CT states. Often, donor-acceptor luminescent materials are constructed by connecting an electron donor moiety such as amino- or carbazole-derivatives and an electron acceptor moiety such as N-containing six-membered aromatic ring.

Devices fabricated in accordance with embodiments of the invention can be incorporated into a wide variety of electronic component modules (or units) that can be incorporated into a variety of electronic products or intermediate components. Examples of such electronic products or intermediate components include display screens, lighting devices such as discrete light source devices or lighting panels, etc. that can be utilized by the end-user product manufacturers. Such electronic component modules can optionally include the driving electronics and/or power source(s). Devices fabricated in accordance with embodiments of the invention can be incorporated into a wide variety of consumer products that have one or more of the electronic component modules (or units) incorporated therein. A consumer product comprising an OLED that includes the compound of the present disclosure in the organic layer in the OLED is disclosed. Such consumer products would include any kind of products that include one or more light source(s) and/or one or more of some type of visual displays. Some examples of such consumer products include a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video wall comprising multiple displays tiled together, a theater or stadium screen, an optical communication device, and a sign. Various control mechanisms may be used to control devices fabricated in accordance with the present invention, including passive matrix and active matrix. Many of the devices are intended for use in a temperature range comfortable to humans, such as 18 C to 30 C, and more preferably at room temperature (20-25 C), but could be used outside this temperature range, for example, from −40 C to 80 C. Additionally, devices fabricated in accordance with embodiments of the invention may be incorporated into optical communication devices.

The materials and structures described herein may have applications in devices other than OLEDs. For example, other optoelectronic devices such as organic solar cells and organic photodetectors may employ the materials and structures. More generally, organic devices, such as organic transistors, may employ the materials and structures.

In some embodiments, the OLED has one or more characteristics selected from the group consisting of being flexible, being rollable, being foldable, being stretchable, and being curved. In some embodiments, the OLED is transparent or semi-transparent. In some embodiments, the OLED further comprises a layer comprising carbon nanotubes.

In some embodiments, the OLED further comprises a layer comprising a delayed fluorescent emitter. In some embodiments, the OLED comprises a RGB pixel arrangement or white plus color filter pixel arrangement. In some embodiments, the OLED is a mobile device, a hand held device, or a wearable device. In some embodiments, the OLED is a display panel having less than 10 inch diagonal or 50 square inch area. In some embodiments, the OLED is a display panel having at least 10 inch diagonal or 50 square inch area. In some embodiments, the OLED is a lighting panel.

In some embodiments of the emissive region, the emissive region further comprises a host.

In some embodiments, the compound can be an emissive dopant. In some embodiments, the compound can produce emissions via phosphorescence, fluorescence, thermally activated delayed fluorescence, i.e., TADF (also referred to as E-type delayed fluorescence), triplet-triplet annihilation, or combinations of these processes.

The OLED disclosed herein can be incorporated into one or more of a consumer product, an electronic component module, and a lighting panel. The organic layer can be an emissive layer and the compound can be an emissive dopant in some embodiments, while the compound can be a non-emissive dopant in other embodiments.

The organic layer can also include a host. In some embodiments, two or more hosts are preferred. In some embodiments, the hosts used maybe a) bipolar, b) electron transporting, c) hole transporting or d) wide band gap materials that play little role in charge transport. In some embodiments, the host can include a metal complex. The host can be an inorganic compound.

Combination with Other Materials

The materials described herein as useful for a particular layer in an organic light emitting device may be used in combination with a wide variety of other materials present in the device. For example, emissive dopants disclosed herein may be used in conjunction with a wide variety of hosts, transport layers, blocking layers, injection layers, electrodes and other layers that may be present. The materials described or referred to below are non-limiting examples of materials that may be useful in combination with the compounds disclosed herein, and one of skill in the art can readily consult the literature to identify other materials that may be useful in combination.

Various materials may be used for the various emissive and non-emissive layers and arrangements disclosed herein. Examples of suitable materials are disclosed in U.S. Patent Application Publication No. 2017/0229663, which is incorporated by reference in its entirety.

### Conductivity Dopants:

A charge transport layer can be doped with conductivity dopants to substantially alter its density of charge carriers, which will in turn alter its conductivity. The conductivity is increased by generating charge carriers in the matrix material, and depending on the type of dopant, a change in the Fermi level of the semiconductor may also be achieved. Hole-transporting layer can be doped by p-type conductivity dopants and n-type conductivity dopants are used in the electron-transporting layer.

### HIL/HTL:

A hole injecting/transporting material to be used in the present invention is not particularly limited, and any compound may be used as long as the compound is typically used as a hole injecting/transporting material.

### EBL:

An electron blocking layer (EBL) may be used to reduce the number of electrons and/or excitons that leave the emissive layer. The presence of such a blocking layer in a device may result in substantially higher efficiencies, and or longer lifetime, as compared to a similar device lacking a blocking layer. Also, a blocking layer may be used to confine emission to a desired region of an OLED. In some embodiments, the EBL material has a higher LUMO (closer to the vacuum level) and/or higher triplet energy than the emitter closest to the EBL interface. In some embodiments, the EBL material has a higher LUMO (closer to the vacuum level) and or higher triplet energy than one or more of the hosts closest to the EBL interface. In one aspect, the compound used in EBL contains the same molecule or the same functional groups used as one of the hosts described below.

### Host:

The light emitting layer of the organic EL device of the present invention preferably contains at least a metal complex as light emitting material, and may contain a host material using the metal complex as a dopant material. Examples of the host material are not particularly limited, and any metal complexes or organic compounds may be used as long as the triplet energy of the host is larger than that of the dopant. Any host material may be used with any dopant so long as the triplet criteria is satisfied.

### HBL:

A hole blocking layer (HBL) may be used to reduce the number of holes and/or excitons that leave the emissive layer. The presence of such a blocking layer in a device may result in substantially higher efficiencies and/or longer lifetime as compared to a similar device lacking a blocking layer. Also, a blocking layer may be used to confine emission to a desired region of an OLED. In some embodiments, the HBL material has a lower HOMO (further from the vacuum level) and or higher triplet energy than the emitter closest to the HBL interface. In some embodiments, the HBL material has a lower HOMO (further from the vacuum level) and or higher triplet energy than one or more of the hosts closest to the HBL interface.

### ETL:

An electron transport layer (ETL) may include a material capable of transporting electrons. The electron transport layer may be intrinsic (undoped), or doped. Doping may be used to enhance conductivity. Examples of the ETL material are not particularly limited, and any metal complexes or organic compounds may be used as long as they are typically used to transport electrons.

### Charge Generation Layer (CGL)

In tandem or stacked OLEDs, the CGL plays an essential role in the performance, which is composed of an n-doped layer and a p-doped layer for injection of electrons and holes, respectively. Electrons and holes are supplied from the CGL and electrodes. The consumed electrons and holes in the CGL are refilled by the electrons and holes injected from the cathode and anode, respectively; then, the bipolar currents reach a steady state gradually. Typical CGL materials include n and p conductivity dopants used in the transport layers.

OLED displays are becoming more efficient through different contributions which may include, for example, blue PHOLEDs (Phosphorescent Organic Light-emitting Diodes), no circular polarizers, and/or improved outcoupling. The increased efficiency may result in lowering the drive currents used by OLED devices to output light. This has two important consequences. Firstly, the actual drive currents become very small, so that they become very difficult to control accurately. Secondly, the OLED response time t can depend on the drive current J such that

$$τ = K / {J}^{n} where K is a constant and n is approximately 1.6 .$$

That is, very low drive currents lead to long transient response times, which may negatively impact display visual performance.

Embodiments of the disclosed subject matter may increase the drive current to an OLED device in an OLED sub-pixel. That is, at low light levels, the current density flowing through the OLED may be increased and the transient response time may be reduced. There may be no significant increase in OLED display power consumption, no significant decrease in OLED lifetimes, and/or no change to OLED device structure.

The active emission area or the spatial resolution of the sub-pixels of a specific color at low grey levels may be changed. In general, a full color display has three or more primary colors so it can produce white light. For each color, the display can render a range of grey levels for that color. The display is often characterized by having G grey levels, where G represents the number of different levels of that color that can be rendered between zero and maximum luminance for that color. The exact brightness of each of these luminance levels may be weighted so that to a human eye they appear linear in brightness.

OLED displays are often refreshed F times per second, given by the frame rate F. This may ensure that moving images do not appear blurred to the user. So, it is important to ensure that the OLED response time is significantly less than a frame time. It is also important to ensure that there is no error in the observed grey level of any given color, where the OLED response time is significantly less than a frame time divided by the number of grey levels. That is, for any given sub-pixel, it needs to be ensured that

$$τ < 1 / ( F * G ) ,$$

where τ is time, F is the frame rate of the display, and G is the number of gray levels for the sub-pixel. This time response of a subpixel may be measured by using a photosensor to monitor the response time of the display when set to a uniform luminance of a primary color and then pulsed so the display turns off. This can be repeated at different uniform display luminances.

In the case of reducing emission area, a new pixel layout may have one or more color sub-pixels having two emission areas within the same deposition area. These two emissive areas may be independently addressed through each having its own scan or select line, using the same data line, or each use the same scan line or select line but have a different data line. Each emissive area may have its own backplane driving circuit based on scan line and data line inputs. This arrangement may be implemented by having one OLED deposition for the two emission areas, and having two independent OLED anode contacts lithographically defined in the backplane. This way, the separation between the two emissive areas may be determined by lithography and not OLED deposition processes, and so can be small (e.g., less than 5 μm, less than 2 μm, or the like) to minimize reductions in the overall sub-pixel fill-factor. In some embodiments, more than two emissive areas may be used. The two emission areas can have different sizes, and the smaller emission area may be 30%, 20%, 10% or 5% of the area of the overall emissive area (i.e., the combination of both emissive areas). Using this approach, one can ensure that even at low light output the current density used to drive an OLED can be high enough to ensure a fast response time.

When the OLED light output of the sub-pixel is to be less than 10% of its maximum value, or less than 30%, or less than 50% of its maximum value, then a controller may start to shut off (or never turn on) the larger emissive area, and the controller may just energize the smaller area to achieve a higher OLED current and achieve the desired luminance then would be possible by just using the larger emissive area. As the overall sub-pixel luminance may be low, there may be no significant power losses and lifetime implications.

Reducing the effective resolution of the sub-pixels of a given color may be another approach to ensure that even at low light output for the given color, the current density used to drive an OLED may be high enough to ensure a fast response time. A controller may be configured to receive an input signal that specifies a luminance for the first sub-pixel and a group of sub-pixels of the same color in N pixels near and including the first sub-pixel, and output an output signal to drive the first sub-pixel at a luminance equal to a sum of luminance values pixel of the plurality of pixels

Different approaches may be used with different color sub-pixels to accelerate a transient response. For example, blue sub-pixels may use a resolution decrease approach, whereas green sub-pixels may use split area approach (e.g., to have a 4 sub-pixel design with three colors). In one arrangement, there may be two different drivable areas within one sub-pixel for one color, and the resolution may be lowered in another color.

In a resolution lowering approach for a display, the resolution may be lowered by N (i.e., an integer value), preferably where N is a square of an integer value. For example, if N=4, both the x-resolution and the y-resolution for a display may be reduced by a factor of 2 (i.e., the square root of 4). In other example, if N=9, both the x-resolution and the y-resolution may be reduced by a factor of 3 (i.e., the square root of 9). In yet another example, when N=16, both the x-resolution and the y-resolution may be reduced by a factor of 4 (i.e., the square root of 16). That is, both the x resolution and y resolution may be reduced by the same factor. In the embodiments described herein, N could be any integer number, where N is less than 101.

In the embodiments of the disclosed subject matter, the value of N may depend on luminance level or the transient response of a subpixel relative to the frame time divided by the number of grey levels. For example, when sub-pixel luminance is in the range of 5% to 20% of maximum luminance that the sub-pixel may produce, N=4. In another example, when sub-pixel luminance is in the range of 1% to 5% of the sub-pixel maximum luminance, N=9 or N=16.

In some embodiments, the value of N may be different for each color sub-pixel. In some embodiments, the value of N may be highest for blue sub-pixels. In some embodiments, the value of N may be highest for green sub-pixels. In some embodiments, the value of N may be highest for red sub-pixels.

When resolution is reduced (e.g., when N=4), then one sub-pixel may have the luminance of the sum of the luminances of the N sub-pixels in a nearest neighbor to and including the sub-pixel being energized. Here, one of the N sub-pixels is turned “on” to a luminance equal to the sum of the luminances of the N sub-pixels and the remaining N−1 sub-pixels are turned “off”. The selection of the “on” and “off” sub-pixels of the N total sub-pixels may be a dynamic arrangement, where the sub-pixel that is turned on may change over time. For example, if 4 sub-pixels of the same color from 4 pixels form one lower resolution super-pixel (i.e., the N total sub-pixels), then at low luminance this lower resolution pixel may have 4 sub-pixels of the same color. These 4 sub-pixels may be energized in sequence with different and/or subsequent frames to improve the display of a visual image and/or reduce burn-in effects in any specific sub-pixel, so that only one of them is energized at any given time. In other words, in a first frame of a display image, the 1^{st} of the Nth sub-pixels is illuminated and the remaining 2^{nd}-4^{th} (in the case of N=4) are not illuminated. Subsequently, in a second frame of a display image, the 2^{nd} of the Nth sub-pixels is illuminated and the remaining 1^{st}, 3^{rd} and 4^{th} are not illuminated. In an embodiment, an output signal from a controller is given to drive the 1^{st} sub-pixel of the N sub-pixels at a luminance that represents the sum of luminance values specified in the input signal for the group of sub-pixels of the same color in the N sub-pixels. In an embodiment, an output signal from a controller is given to drive the 1^{st} sub-pixel of the N sub-pixels at a luminance that represents 75-125% of the sum of luminance values specified in the input signal for the group of sub-pixels of the same color in the N sub-pixels.

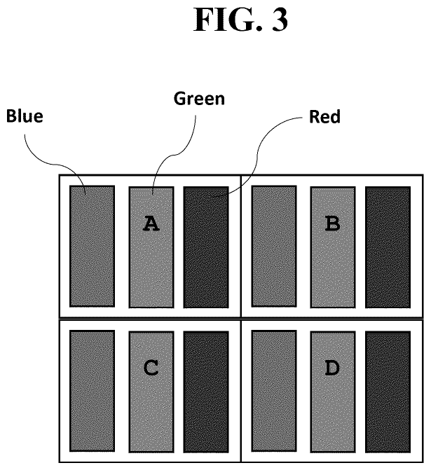

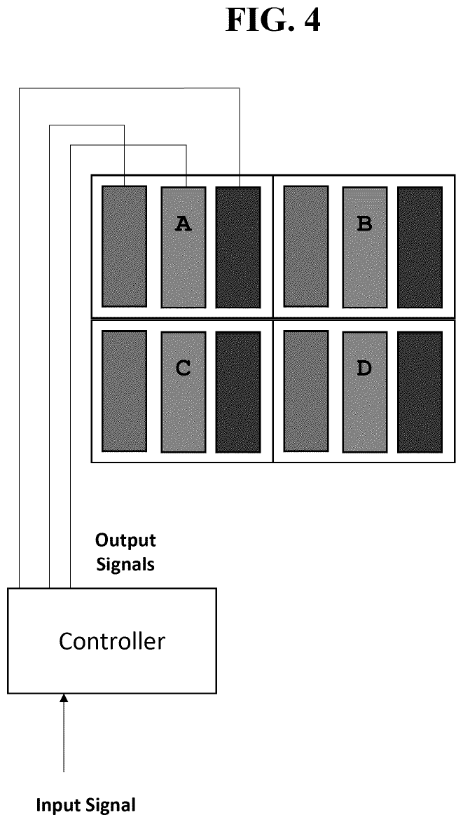

In an example, N=4 for a group of four pixels such as shown in FIGS. 3-4. It may be desirable to increase the sub-pixel drive current to reduce transient response. One sub-pixel of a particular color amongst the four pixels may be energized at any given time, and it may be driven such that its luminance is the sum of the 4 sub-pixels of the particular color (e.g., red, green, or blue) in the 4 pixels shown. To improve visual performance of the lower resolution image, every frame time a different sub-pixel of that color from the four pixel grouping may be illuminated. For example, in frame n the sub-pixel A may be used, frame n+1 may use sub-pixel B, frame n+2 may use sub-pixel 3, and frame n+3 may use sub-pixel D. In some embodiments, this order may be repeated.

When N>1 for a specific color, N pixels may be grouped together, as they will only have one active sub-pixel for that color at any given time. This grouping may be referred to as a “super pixel.”

According to an embodiment, such as shown in FIGS. 3-4, a device may include a plurality of pixels, where each pixel of the plurality of pixels comprises three or more sub-pixels, and where a first sub-pixel of the three or more sub-pixels of a first pixel of the plurality of pixels emits a first color light. A controller may be communicatively coupled to the plurality of pixels. The controller may be configured to receive an input signal that specifies a luminance for the first sub-pixel and a group of sub-pixels that emit the first color light in N pixels, where the N pixels comprise the first pixel and at least one pixel adjacent to the first pixel, and the controller may be configured to output an output signal to drive the first sub-pixel at a luminance equal to a sum of luminance values specified in the input signal for the group of sub-pixels that emit the first color light in the N pixels and output a signal to drive the remaining sub-pixels that emit the first color light in the N pixels at zero luminance. The controller of FIG. 4 shows a first communication line to a red sub-pixel, a second communication line to a green sub-pixel, and a third communication line to a blue sub-pixel of one pixel of the four pixels. The first communication line, the second communication line, and/or the third communication line may transmit one or more output signals from the controller. Although only the first communication line, the second communication line, and the third communication line are shown, there may be other communication lines that communicatively connect the controller to the other sub-pixels of each of the four pixels shown in FIG. 4. It is possible that when N is greater than 2, that more than 1, but less than N, sub-pixels of a given color in a group of N pixels may be energized at any given time.

As used throughout, a first sub-pixel that is “adjacent” to a second sub-pixel may be directly next to each other, in other words, the first sub-pixel is within a first pixel and the second sub-pixel is within a second pixel and the first pixel and second pixel are directly next to each other. Additionally, an “adjacent” sub-pixel refers to a sub-pixel that is within a pixel pitch distance relative to another sub-pixel, or a sub-pixel that is within a number of pixel units from another sub-pixel. These pixel pitch distances can be from the center of a sub-pixel (i.e., the first sub-pixel) to the center of a sub-pixel of the N pixels. For example, an “adjacent” sub-pixel may refer to a sub-pixel that is within a pixel pitch of 5 or less, or within a pixel pitch of 10 or less relative to another sub-pixel. Thus, as used herein, two sub-pixels are “adjacent” one another if they are within any of these distances, unless a particular type or form of measurement is specified or required by context.

The output signal may specify a drive current of zero to turn off sub-pixels that emit the first color light in N−1 pixels of the N pixels, where the N−1 pixels do not include the first pixel. In some embodiments, the specified drive current of zero may mean that there still could be a residual amount of current flowing in the pixel and/or luminance output from the pixel.

The output signal may be configured to drive the first sub-pixel at a luminance in a display equal to a sum of luminance values for the group of sub-pixels that emit the first color light of the N pixels when the response time of the first sub-pixel is above a threshold value. The threshold value may be at least 25%, at least 50%, at least 100%, at least 200%, at least 300%, and/or at least 400% of the time defined by 1/(F*G), where F is a number of frames per second for the device (e.g., a display) and G is a number of grey levels for the sub-pixel. The output signal may specify a drive current of zero to turn off sub-pixels that emit the first color light in N−1 pixels of the N pixels, where the N−1 pixels do not include the first pixel.

The output signal configured to drive the first sub-pixel at a luminance equal to a sum of luminance values specified in the input signal for the group of sub-pixels that emit the first color light in the N pixels may be an output a signal to drive the first sub-pixel at a luminance equal to at least 75%, at least 100%, and/or at least 125% of the sum of luminance values specified in the input signal for the group of sub-pixels that emit the first color light in the N pixels.

The output signal may be configured to drive the first sub-pixel at a luminance equal to a sum of luminance values for the group of sub-pixels that emit the first color light that of the N pixels when the luminance of the first sub-pixel is below a threshold value. The threshold value may be 5% of a maximum luminance value of the first sub-pixel, 10% of a maximum luminance value of the first sub-pixel, and/or 20% of a maximum luminance value of the first sub-pixel. The output signal may specify a drive current of zero to turn off sub-pixels that emit the first color light in N−1 pixels of the N pixels, where the N−1 pixels do not include the first pixel.

In some embodiments, the controller may be configured to output one or more signals to control which sub-pixel or sub-pixels of the N pixels is driven at any given time. In some embodiments, the controller may sequentially turn on sub-pixels, and/or may turn on the sub-pixels based on a pattern, and/or may randomly turn on sub-pixels without a particular pattern. The one or more signals that are output by the controller may drive more than one sub-pixel of the N pixels at a time. For example, when N=9 and/or when N=16, there may be two (or more) sub-pixels illuminated at one time and the two (or more) sub-pixels that are illuminated have a combined luminance that is equal to the combined luminance of the N sub-pixels, had all N sub-pixels been driven.

In some embodiments, the first color light may be green light. In some other embodiments, the first color light may be blue light. In some embodiments, the first color light may be red light. In some embodiments, the first color light may be white light.

The output signal may be configured to drive the first sub-pixel at a luminance equal to a sum of luminance values for the group of sub-pixels that emit the first color light of the N pixels when the luminance of the first sub-pixel is below a threshold value, where the threshold value may be 5% maximum luminance value of the first sub-pixel, 10% maximum luminance value of the first sub-pixel, and/or 20% of a maximum luminance value of the first sub-pixel. In some embodiments, the threshold value of the first sub-pixel may be 5%, 10%, 15%, and/or 20% of a maximum luminance value of the first sub-pixel when N=4. In other embodiments, the threshold value may be 1%, 2%, 3%, 4%, 5%, and/or 10% of the maximum luminance value of the first sub-pixel when N=9 or N=16.

A value for N may be based on the first color light to be emitted by the first sub-pixel. In some embodiments, the value for N may be highest when the first color light is blue light. In other embodiments, the value for N may be highest when the first color light is white, green, red, and/or yellow light.

When N>1 for a first color light, at least a portion of the plurality of pixels may be grouped together to have one or more active sub-pixels for the first color light, where the grouping forms a super-pixel of the N pixels. As used throughout, a “super-pixel” may be a group of a plurality of pixels that are treated as a single pixel logically. The super-pixel may have a plurality of sub-pixels, and only a subset of sub-pixels, generally a single sub-pixel or one or more sub-pixels, of the plurality of sub-pixels of the super-pixel may be energized and be active at any given time, and the surrounding sub-pixels may be turned off or on. The sub-pixels may be turned on or off in a predetermined order, or may be turned on or off in a random pattern. Over subsequent frames, the sub-pixel of a given color which is active may be changed within the super-pixel, so each sub-pixel of the first color in the super-pixel is energized once every N frames. N may be a perfect square and the super-pixel may include the square root of N pixels in an x-direction and the square root of N pixels in a y-direction in a display.

The controller may apply an adjustment value to the output signal to drive the first sub-pixel. The output signal to drive the first sub-pixel may include the sum of luminance values for the group of sub-pixels that emit the first color light multiplied by the adjustment value. As described above, the adjustment value may ensure that the perceived brightness of any given color of a super-pixel is independent of the number of sub-pixels of that color that is energized at any given time.

In some embodiments, the adjustment value may be a gamma correction value to adjust for a non-linear perception of brightness. When evaluating an image or video, a controller coupled to one or more pixels may decode an image in RGB (Red, Green, Blue) format. For example, an 8 bit color depth may be used (e.g., [0,0,0] for a black pixel, [255,255,255] for white, [0,255,0] for green, and the like). In this 8 bit color space, the intensity from 0 to 255 may not be uniform as perceived by the eye. It is therefore necessary to change to a different color space. 1976 CIE-LAB color space (L*a*b*) is close to one where it is uniform as perceived by the eye. In 1976 CIE-LAB color space, the a* and b* components are R/G and B/Y components, respectively, and indicate the chromaticity (hue and chroma). The a* value goes from red to green, where +a is redder, and −a is greener in color. The b* value goes from yellow to blue, where +b is yellower, and −b is bluer in color. The L* value is the brightness, where a high L* value is bright, and a low L* value is dark.

To change the image from the RGB color space to 1976 CIE-LAB color space, the controller and/or software executing thereon may split the split the image into three distinct colors (R, G, B), and convert the 8-bit monochrome images to the LAB color space. The controller may identify a super-pixel size of N pixels where when all sub-pixels of one color are below a preset value and only one sub-pixel may be energized at any given time. In an alternative embodiment, one or more of the sub-pixels of the one color are below a preset value. The controller may sum the brightness (L*) value of all sub-pixels in the super-pixel, and may set the value of one of the sub-pixels to a calculated value in the brightness summation operation, and may set the remaining sub-pixels to zero. The controller may convert the image back to 8-bit RGB, and set the new values in the original image. In an alternative embodiment, the controller may energize more than one sub-pixel of the super-pixel size of N pixels.

In an alternative embodiment, in an electronic OLED display pixels may be configured to change their luminance and/or color at a rate dependent on both the image to be rendered and the frame rate of the display. The switching speed of each pixel may be impacted by intrinsic electronic processes of the OLED (e.g. excited state lifetime, charge trapping kinetics in the OLED organic layers, the circuit and capacitance around each OLED device, etc.).

When an OLED device is turned on, the rate at which the light output from the OLED increases to its steady state value may be impacted by the capacitance of the OLED device and the capacitance of the circuit around the OLED device. First, the number of frames it takes to fully charge these capacitances may be directly related to the current available to charge them. Second, the time of the OLED device to reach the steady state light level may be directly related to the current available. At low luminance and/or low drive currents, these charging times can be several frames long. Therefore, at low luminance and/or low drive currents, it may take several frames before sub-pixels produce light at the desired luminance values after the image data requires their luminance to be increased. To speed up the turn-on time and/or time to stabilize the pixel's luminance, the following embodiments lower the effective resolution of the display around portions of the image that need to be made brighter, so as to increase the drive current to selected sub-pixels to reduce the charging time and therefore the time to reach the correct steady-state luminance. Over time, or frames, the current to selected sub-pixels may be reduced to a steady state value, and the current to neighboring sub-pixels may be increased to achieve the desired luminance from all sub-pixels and the full resolution of the display.

In an alternative embodiment, a controller may be communicatively coupled to a plurality of sub-pixels in a device. The controller may receive an input signal that specifics a luminance increase for a first sub-pixel and a group of sub-pixels that emit the first color light in N pixels, where the N pixels comprise the first pixel and at least one pixel adjacent to the first pixel. The controller may output a signal to drive the first sub-pixel at a luminance increase equal to at least 25% of the sum of the luminance increase values specified in the input signal for the group of sub-pixels that emit the first color light in the N pixels.

In an alternative embodiment, similar to embodiments above, when N>1 for a first color of light, at least a portion of the plurality of pixels may be grouped together to have one or more active sub-pixels for the first color of light. The grouping may form a super-pixel of the N pixels. The one or more active sub-pixels for the first color of light may comprise only one sub-pixel of the N pixels. The super-pixel may have a plurality of sub-pixels, and one or more sub-pixels of the plurality of sub-pixels of the super-pixel may be energized at any given time. Over subsequent frames, the sub-pixel of a given color which is active may be changed within the super-pixel, so each sub-pixel of the first color is energized once every N frames. N may be a perfect square and the super-pixel may include the square root of N pixels in an x-direction and the square root of N pixels in a y-direction of a display.

In an embodiment, the input signal to the controller may be for one or more frames to be displayed on the device. In an embodiment, the output signal from the controller may drive the N sub-pixels and/or the first sub-pixel for at least a first frame of the one or more frames. In an embodiment, the output signal may specify a drive current of less than 25% of the sum of the luminance increase (i.e., adjusting the luminance for changes) to at least one of the sub-pixels that emit the first color light in N−1 pixels of the N pixels. In an alternative embodiment, the output signal may specify a drive current that is less than 20%, less than 15%, less than 10%, less than 7%, and/or less than 5% of the sum of the luminance increase to at least one of the sub-pixels that emit the first color light in N−1 pixels of the N pixels.

In an embodiment, the output signal from the controller to drive the first sub-pixel may be at a luminance increase equal to at least 50% of the sum of the luminance increase values specified in the input signal for the group of sub-pixels that emit the first color light in the N pixels. In an alternative embodiment, the output signal to drive the first sub-pixel may be a luminance increase equal to at least 70%, an increase equal to at least 90%, an increase equal to at least 100%, and/or an increase greater than 100% of the sum of the luminance increase values specified in the input signal for the group of sub-pixels that emit the first color light in the N pixels.

In an embodiment, N=2, where N is the number of pixels is a device. In an alternative embodiment, N=4. In an alternative embodiment, N=9. In yet another alternative embodiment, N may be any integer less than the number of total pixels in the device. In an embodiment, the N may be an integer that is less than 101.

In an embodiment, the first color light may be green light. In an alternative embodiment, the first color light may be blue light. In an alternative embodiment, the first color light may be red light. In an alternative embodiment, the first color light may be white light. In an alternative embodiment, the first color light may be yellow light.

In an embodiment, the output signal from the controller that drives the first sub-pixel at luminance increase may be equal to at least 10% of the sum of the luminance increase values specified in the input signal for the group of sub-pixels that emit the first color light in the N pixels. Here, the output signal may specify a drive current of less than 10% of the sum of the luminance increase to at least one of the sub-pixels that emit the first color light in N−1 pixels of the N pixels, where the N−1 pixels do not include the first pixel. In this embodiment, the output signal may specify a drive current for the N pixels that provides a luminance increase to the group of sub-pixels that emit the first color light in N pixels may be withing+/−20% of the sum of the input signal luminance increase for the first sub-pixel and a group of sub-pixels that emit the first color light in the N−1 pixels. In an alternative embodiment, the output signal may specify a drive current for the N pixels that provides a luminance increase to the group of sub-pixels that emit the first color light in N pixels within plus or minus 10% of the sum of the input signal luminance increase for the first sub-pixel and a group of sub-pixels that emit the first color light in the N−1 pixels. In yet another alternative embodiment, the output signal may specify a drive current for the N pixels that provides a luminance increase to the group of sub-pixels that emit the first color light in N pixels within plus or minus 5% of the sum of the input signal luminance increase for the first sub-pixel and a group of sub-pixels that emit the first color light in the N−1 pixels.

In an embodiment, when the input signal is for a plurality of frames to be displayed on the device, the output signal to drive the first sub-pixel may be for one or more frames of the plurality of frames. Here, the output signal may be to drive the first sub-pixel at a luminance increase greater or less than 100% of the sum of the luminance increase values specified in the input signal for the group of sub-pixels that emit the first color light in the N pixels.

In an embodiment, the luminance increase for the first sub-pixel and a group of sub-pixels that emit the first color light in the N pixels for a first frame of the one or more frames to be displayed on the device, relative to a second frame of the one or more frames, where the second frame is to be displayed before the first frame on the device may be less than 10 nits. In an alternative embodiment, the luminance of the first sub-pixel and a group of sub-pixels that emit the first color light in N pixels for a first frame of the one or more frames to be displayed on the device, relative to a second frame of the one or more frames, wherein the second frame is to be displayed before the first frame on the device may be less than 5 nits, less than 10 nits, less than 25 nits, less than 50 nits, less than 100 nits, and/or greater than 100 nits. Here, the at least one or more frames before the frames for the input signal may be the frames displayed before the frames to be displayed by the input signal.

In an embodiment, the luminance of the first sub-pixel and a group of sub-pixels that emit the first color light in N pixels n for the one or more frames directly before the one or more frames for the input signal received by the controller may be 0 nits. In an alternative embodiment, the luminance of the first sub-pixel and a group of sub-pixels that emit the first color light in N pixels for the one or more frames before the one or more frames for the input signal received by the controller may be 0 nits, less than 5 nits, less than 10 nits, less than 25 nits, less than 50 nits, and/or less than 100 nits.

In an embodiment, the input signal to the controller may be for a plurality of frames to be displayed on the device. The output signal to drive the first sub-pixel may be at a luminance increase greater than 25% of the sum of the luminance increase values specified in the input signal for the group of sub-pixels that emit the first color light in the N pixels for one or more frames of the plurality of frames. The output signal to drive the first sub-pixel may be at a specified luminance increase for the first sub-pixel in the received input signal for the remaining frames of the plurality of frames after the one or more frames of the plurality of frames. In other words, when an input signal is received for a plurality of frames, a first group of the plurality of frames may have a input signal for the first sub-pixel that is greater than the received input signal for that first sub-pixel and an output signal for a remainder of the frames of the plurality of frames not including the initial one or more frames may be at or near (within 20%) of the original received input signal.

In an embodiment, where a grouping forms a super-pixel of the N pixels, the first sub-pixel of the first pixel that receives the luminance increase (and the remaining sub-pixels of the same color in the N pixels not including the first pixel) may be the sub-pixel that is increased in luminance for a period of frames. For example, this may be 100 frames, 1000 frames, or 10,000 frames. After a set period of frames, the first sub-pixel may be rotated to another sub-pixel of the same color in the N pixels. This allows for the increased luminance sub-pixel to be rotated throughout the N pixels, thus increasing the lifetime of the device because no single sub-pixel is always receiving the greatest luminance increase for all frames. In an alternative embodiment, instead of rotating the first sub-pixel by frames, this first sub-pixel may be rotated by time. In other words, every 1 second, 5 second, 15 seconds, 30 seconds, 60 seconds, or greater than 60 seconds, etc.

In an embodiment, the size of N may be modified by the controller based on a frame rate, a pixel resolution of the input signal, a brightness of the input signal, and/or a color of the input signal.

A consumer electronic device having the one or more of the embodiments of the device described herein may be a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video wall comprising multiple displays tiled together, a theater or stadium screen, optical communication device, and/or a sign.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

1. A device comprising:
a plurality of pixels, wherein each pixel of the plurality of pixels comprises three or more sub-pixels, wherein a first sub-pixel of the three or more sub-pixels of a first pixel of the plurality of pixels emits a first color light; and
a controller communicatively coupled to the plurality of pixels, wherein the controller is configured to:
receive an input signal that specifies a luminance for the first sub-pixel and a group of sub-pixels that emit the first color light in N pixels, wherein the N pixels comprise the first pixel and at least one pixel adjacent to the first pixel; and
output an output signal to drive the first sub-pixel at a luminance equal to a sum of luminance values specified in the input signal for the group of sub-pixels that emit the first color light in the N pixels.

2. The device of claim 1, wherein the output signal specifies a drive current of zero to turn off sub-pixels that emit the first color light in N−1 pixels of the N pixels, wherein the N−1 pixels do not include the first pixel.

3. The device of claim 1, wherein the output signal is configured to drive the first sub-pixel at a luminance equal to a sum of luminance values for the group of sub-pixels of that emit the first color light of the N pixels when the luminance of the first sub-pixel is below a threshold value, and wherein the threshold value is at least one selected from a group consisting of: 5% of a maximum luminance value of the first sub-pixel, 10% of a maximum luminance value of the first sub-pixel, and 20% of a maximum luminance value of the first sub-pixel.

4. The device of claim 3, wherein the output signal specifies a drive current of zero to turn off sub-pixels that emit the first color light in N−1 pixels of the N pixels, wherein the N−1 pixels do not include the first pixel.

5. The device of claim 1, wherein the controller is configured to output one or more signals to control which sub-pixel of the N pixels is driven at any given time.

6. The device of claim 5, wherein the one or more signals that are output by the controller drives more than one sub-pixel of the N pixels at a time.

7. The device of claim 1, wherein the first color light is green light.

8. The device of claim 1, wherein the first color light is blue light.

9. The device of claim 1, wherein the first color light is red light.

10. The device of claim 1, wherein the first color light is white light.

11. The device of claim 1, wherein the output signal to drive the first sub-pixel is selected from a group consisting of: 5% of a maximum luminance value of the first sub-pixel, 10% of a maximum luminance value of the first sub-pixel, 15% of a maximum luminance value of the first sub-pixel, and 20% of a maximum luminance value of the first sub-pixel when N=4, and
wherein the output signal to drive the first sub-pixel is selected from a group consisting of: 1% of a maximum luminance value of the first sub-pixel, 2% of a maximum luminance value of the first sub-pixel, 3% of a maximum luminance value of the first sub-pixel, 4% of a maximum luminance value of the first sub-pixel, 5% of a maximum luminance value of the first sub-pixel, and 10% of a maximum luminance value of the first sub-pixel when N=9 or N=16.

12. The device of claim 1, wherein a value for N is based on the first color of light to be emitted by the first sub-pixel.

13. The device of claim 12, wherein the value for N is highest when the first color light is blue light.

14. The device of claim 12, wherein the value for N is highest when the first color light is selected from a group consisting of: green light, red light, yellow light, and white light.

15.-18. (canceled)

19. The device of claim 1, wherein the controller applies an adjustment value to the output signal to drive the first sub-pixel.

20. The device of claim 19, wherein the output signal to drive the first sub-pixel includes the sum of luminance values for the group of sub-pixels that emit the first color light multiplied by the adjustment value.

21. The device of claim 1, wherein the output signal is configured to drive the first sub-pixel at a luminance equal to the sum of luminance values for the group of sub-pixels that emit the first color light when a time response of the first sub-pixel is longer than a threshold time, and wherein the threshold time is at least one selected from a group consisting of: at least 25%, at least 50%, at least 100%, at least 200%, at least 300%, and at least 400% of the time defined by 1/(F*G),
where F is a number of frames per second for the device, and G is a number of grey levels for the first sub-pixel.

22. The device of claim 1, wherein the output signal configured to drive the first sub-pixel at a luminance equal to a sum of luminance values specified in the input signal for the group of sub-pixels that emit the first color light in the N pixels is an output a signal to drive the first sub-pixel at a luminance selected from a group consisting of: at least 75%, at least 100%, and at least 125% of the sum of luminance values specified in the input signal for the group of sub-pixels that emit the first color light in the N pixels.

23. A consumer electronic device comprising the device of claim 1.

24. The consumer electronic device of claim 23, wherein the device is at least one type selected from a group consisting of: a flat panel display, a curved display, a computer monitor, a medical monitor, a television, a billboard, a light for interior or exterior illumination and/or signaling, a heads-up display, a fully or partially transparent display, a flexible display, a rollable display, a foldable display, a stretchable display, a laser printer, a telephone, a cell phone, tablet, a phablet, a personal digital assistant (PDA), a wearable device, a laptop computer, a digital camera, a camcorder, a viewfinder, a micro-display that is less than 2 inches diagonal, a 3-D display, a virtual reality or augmented reality display, a vehicle, a video wall comprising multiple displays tiled together, a theater or stadium screen, an optical communication device, and a sign.

25.-59. (canceled)
